(19) United States
(12) Patent Application Publication
(10) Pub. No.: US 2026/0153792 A1
(43) Pub. Date: Jun. 4, 2026

(54) REFLECTIVE MODULE AND CAMERA MODULE INCLUDING THE SAME

(71) Applicant: Samsung Electro-Mechanics Co., Ltd., Suwon-si (KR)

(72) Inventors: Ji Hoon CHOI, Suwon-si (KR); Young Bok YOON, Suwon-si (KR); Ho Sik YOO, Suwon-si (KR); Young Hwan KWON, Suwon-si (KR)

(73) Assignee: Samsung Electro-Mechanics Co., Ltd., Suwon-si (KR)

(21) Appl. No.: 19/259,320

(22) Filed: Jul. 3, 2025

(30) Foreign Application Priority Data
Nov. 29, 2024 (KR) 10-2024-0174939

(51) Int. Cl. G03B 17/17; G02B 7/182; G03B 5/00; G03B 17/12; G03B 30/00

(52) U.S. Cl. CPC G03B 17/17; G02B 7/1821; G03B 5/00; G03B 17/12; G03B 30/00; G03B 2205/0023; G03B 2205/003; G03B 2217/002

(57) ABSTRACT

A reflective module includes a housing; a guide member disposed in the housing and configured to rotate about a first rotation axis; a reflective member configured to rotate together with the guide member about the first rotation axis and having a reflective surface; and a first ball member disposed between the housing and the guide member. The first rotation axis is formed to be inclined with respect to each of a side surface and a bottom surface of the housing.

### CROSS-REFERENCE TO RELATED APPLICATIONS

This application claims the benefit under 35 USC 119(a) of Korean Patent Application No. 10-2024-0174939 filed on Nov. 29, 2024, in the Korean Intellectual Property Office, the entire disclosure of which is incorporated herein by reference for all purposes.

### BACKGROUND

### 1. Field

The present disclosure relates to a reflective module and a camera module including the same.

### 2. Description of the Background

A mobile device may include a camera module that bends a traveling path of light through a reflective module.

The camera module may perform optical image stabilization during photography by rotating a reflective member about two axes perpendicular to each other.

Even though image stabilization may be performed through two-axis rotation of a reflective member, the structure for rotating the reflective member may be complicated, and accordingly, potentially increase the size of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflective module includes a housing; a guide member disposed in the housing and configured to rotate about a first rotation axis; a reflective member configured to rotate together with the guide member about the first rotation axis and having a reflective surface; and a first ball member disposed between the housing and the guide member. The first rotation axis is formed to be inclined with respect to each of a side surface and a bottom surface of the housing.

The first rotation axis may be parallel to the reflective surface.

The housing may have an inclined surface disposed between the side surface and the bottom surface. The guide member may have a surface opposing the inclined surface in a direction perpendicular to the first rotation axis.

The first ball member may include a plurality of balls spaced apart from each other in a direction of the first rotation axis.

The housing may have an inclined surface disposed between the side surface and the bottom surface. Guide grooves spaced apart from each other in the direction of the first rotation axis may be disposed in the inclined surface, and the first ball member may be disposed in the guide grooves.

The reflective module may further include a first driving unit including a first magnet disposed on the guide member and a first coil opposing the first magnet. The first magnet and the first coil may be configured to generate a driving force in a direction perpendicular to the first rotation axis.

One surface of the first magnet, opposing the first coil, may have a first polarity and a second polarity spaced apart from each other in a direction perpendicular to the first rotation axis. The first polarity and the second polarity may have opposite polarities.

A first magnetic component may be disposed in one of the housing and the guide member, a second magnetic component is disposed in another of the housing and the guide member, and the first magnetic component and the second magnetic component may oppose each other.

The first ball member may be disposed between the housing and the guide member. The first ball member may include a plurality of balls spaced apart from each other in the direction of the first rotation axis. The first magnetic component and the second magnetic component may be disposed between the plurality of balls.

The reflective module may further include a holder disposed to rotate about the guide member with respect to a second rotation axis perpendicular to the first rotation axis, wherein the reflective member is mounted on the holder.

The reflective module may further include a second driving unit including a second magnet disposed on the holder and a second coil opposing the second magnet; and a second ball member, disposed between the guide member and the holder, including a plurality of balls spaced apart from each other in a direction of the second rotation axis.

A camera module may include the reflective module above; and a first lens module having a first optical axis and spaced apart from the reflective member in a direction of the first optical axis.

In another general aspect, a camera module includes a housing; a guide member disposed to rotate about a first rotation axis with respect to the housing; a reflective member having a reflective surface and configured to rotate together with the guide member about the first rotation axis; a first lens module having a first optical axis and spaced apart from the reflective member in a direction of the first optical axis; and a first ball member disposed between the guide member and the housing. The housing has an inclined surface, inclined with respect to the first optical axis, and the first ball member is disposed on the inclined surface.

The camera module may further include a second lens module to which light reflected from the reflective surface is incident, and having a second optical axis. The first optical axis and the second optical axis may be perpendicular to each other.

The first ball member may include a plurality of balls spaced apart from each other in the direction of the first rotation axis. A conceptual line connecting the plurality of balls may be inclined with respect to each of the first optical axis and the second optical axis.

The first rotation axis may be parallel to the reflective surface.

Other features and aspects will be apparent from the following detailed description, the drawings, and the claims.

### BRIEF DESCRIPTION OF DRAWINGS

FIG. 1 is a perspective diagram illustrating a camera module according to an embodiment of the present disclosure.

FIG. 2 is an exploded perspective diagram illustrating a camera module according to an embodiment of the present disclosure.

FIG. 3 is a cross-sectional diagram taken along line I-I′ in FIG. 1;

FIG. 4 is an exploded perspective diagram illustrating a reflective module according to an embodiment of the present disclosure.

FIGS. 5 and 6 are diagrams illustrating the example in FIG. 4, viewed in different directions.

FIG. 7 is an exploded perspective diagram illustrating a housing and a guide member according to an embodiment of the present disclosure.

FIG. 8 is an exploded perspective diagram illustrating a guide member, a holder, a first driving unit, and a second driving unit according to an embodiment of the present disclosure.

FIGS. 9 and 10 are perspective diagrams illustrating a state in which a second lens module is separated from a camera module according to an embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Embodiments relate to a camera module 1, and the camera module 1 may be mounted on portable electronic devices such as a mobile communication terminal, a smartphone, and a tablet PC.

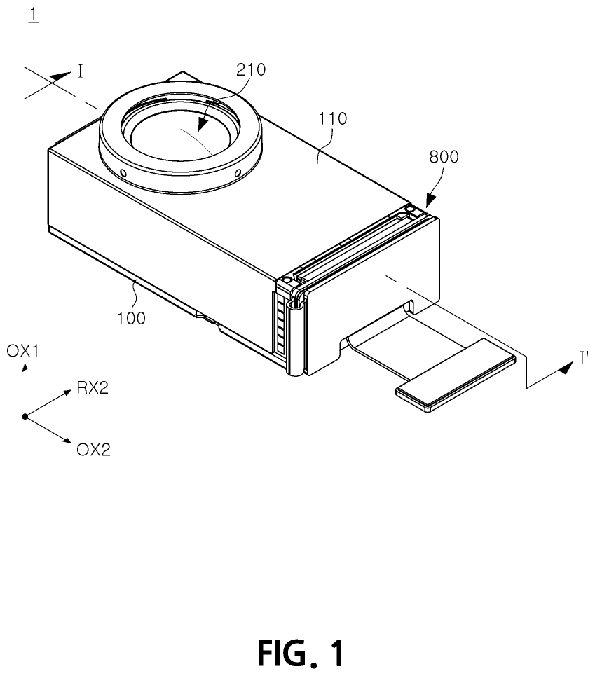

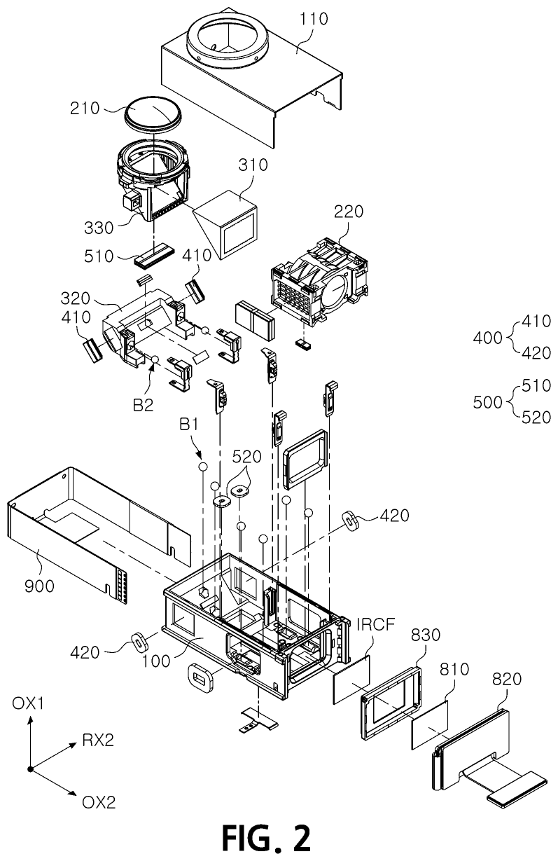

FIG. 1 is a perspective diagram illustrating a camera module according to an embodiment. FIG. 2 is an exploded perspective diagram illustrating a camera module according to an embodiment.

Referring to FIGS. 1 and 2, a camera module 1, according to an embodiment, may include a reflective module 300 and a housing 100.

The reflective module 300 may be disposed in the housing 100 and may include a reflective member 310 having a reflective surface 311.

The reflective module 300 may be disposed to rotate about at least two different axes for optical image stabilization. For example, the reflective module 300 may rotate about two axes perpendicular to each other.

In an embodiment, the camera module 1 may further include a first lens module 210.

The first lens module 210 may include at least one lens, and at least one lens may have a first optical axis OX1. The first optical axis OX1 may extend in the vertical direction with respect to FIG. 2. The first optical axis OX1 may pass through a center of at least one lens of the first lens module 210.

In an embodiment, the first lens module 210 may include at least one lens and a first lens barrel. At least one lens may be disposed in the first lens barrel, and the first lens barrel may be coupled to the reflective module 300.

Alternatively, the first lens module 210 may include only at least one lens, and at least one lens may be directly coupled to the reflective module 300.

The first lens module 210 may be disposed on a front side of the reflective module 300. Here, the “front side” may indicate a positive first optical axis OX1 direction (+OX1 axis direction) with respect to the reflective module 300. For example, the first lens module 210 may be disposed above the reflective module 300 in the first optical axis OX1 direction.

The first lens module 210 may be coupled to the reflective module 300. For example, the first lens barrel of the first lens module 210 may be coupled to a holder 330 of the reflective module 300.

The first lens module 210 and the reflective module 300 may be disposed in the housing 100.

In an embodiment, the camera module 1 may further include a second lens module 220. The reflective module 300 may be disposed between the first lens module 210 and the second lens module 220. The second lens module 220 may include a plurality of lenses and may have a second optical axis OX2. The plurality of lenses may be disposed along the second optical axis OX2. The second optical axis OX2 may pass through a center of a plurality of lenses of the second lens module 220.

The first optical axis OX1 of the first lens module 210 and the second optical axis OX2 of the second lens module 220 may be formed to be perpendicular to each other.

The first lens module 210 may include one or more lenses, and the second lens module 220 may include a plurality of lenses.

The first lens module 210 and the reflective module 300 may be configured to rotate together for optical image stabilization. The second lens module 220 may move in the second optical axis OX2 direction for focusing.

The camera module 1 may further include an image sensor module 800. The image sensor module 800 may be disposed on a rear side of the second lens module 220. When camera module 1 does not include the second lens module 220, the image sensor module 800 may be disposed on the rear side of the reflective module 300.

The image sensor module 800 may include a sensor housing 830, an image sensor 810, and a printed circuit board 820, and may further include an infrared cutoff filter (IRCF).

The infrared cutoff filter (IRCF) may be mounted on the sensor housing 830. The infrared cutoff filter (IRCF) may block light in an infrared region of light passing through the second lens module 220.

The printed circuit board 820 may be coupled to the sensor housing 830, and the image sensor 810 may be disposed in a printed circuit board 820.

Light passing through the second lens module 220 may be received by the image sensor module 800 (e.g., image sensor 810).

The camera module 1 may further include a case 110. The case 110 may be coupled to the housing 100 so as to cover an upper portion of the housing 100. The case 110 may have an opening, and the first lens module 210 may be disposed in the opening.

The first lens module 210 may be disposed such that at least a portion thereof may protrude externally of the housing 100 and the case 110.

In the embodiment, the reflective module 300, the first lens module 210, and the second lens module 220 may be disposed in the housing 100, or the reflective module 300 and the first and second lens modules 210 and 220 may be disposed in different housings, respectively.

In this case, the housing 100 may be included as one component of the reflective module 300.

Also, referring to FIG. 2, the camera module 1 may include both the first lens module 210 and the second lens module 220. However, an embodiment thereof is not limited thereto, and the camera module 1 may include only one of the first lens module 210 and the second lens module 220.

In an embodiment, the first lens module 210 and the reflective member 310 may be configured to rotate together for optical image stabilization. That is, the first lens module 210 and the reflective member 310 may rotate together about two axes perpendicular to each other.

For example, the first lens module 210 and the reflective member 310 may rotate together about the first rotation axis RX1, and may rotate together about the second rotation axis RX2 perpendicular to the first rotation axis RX1.

The first rotation axis RX1 may be formed to have an acute angle with respect to each of the first optical axis OX1 and the second optical axis OX2. For example, the sum of an angle between the first optical axis OX1 and the first rotation axis RX1 and an angle between the second optical axis OX2 and the second rotation axis RX2 may be 90°.

In an embodiment, the first rotation axis RX1 may have an inclined shape with respect to each of the first optical axis OX1 and the second optical axis OX2.

The second rotation axis RX2 may be perpendicular to both the first optical axis OX1 and the second optical axis OX2.

In an embodiment, the second lens module 220 may move in the second optical axis OX2 direction for focusing.

The first rotation axis RX1 and the second rotation axis RX2 may be spaced apart from each other in a direction perpendicular to the reflective surface 311.

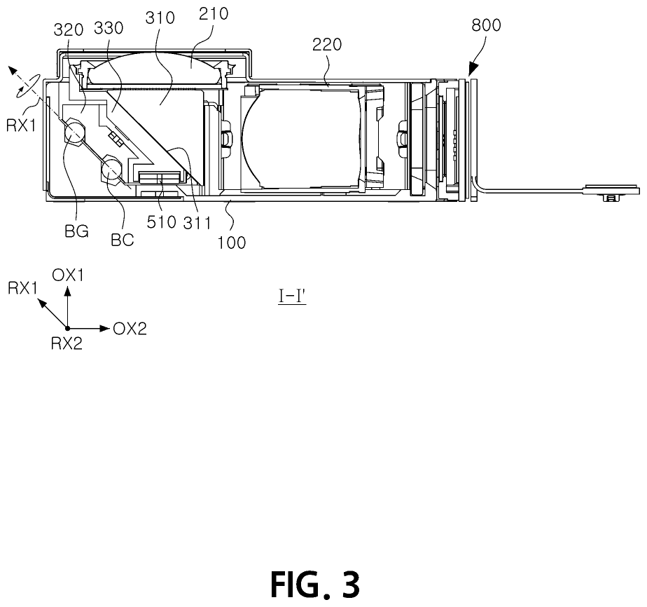

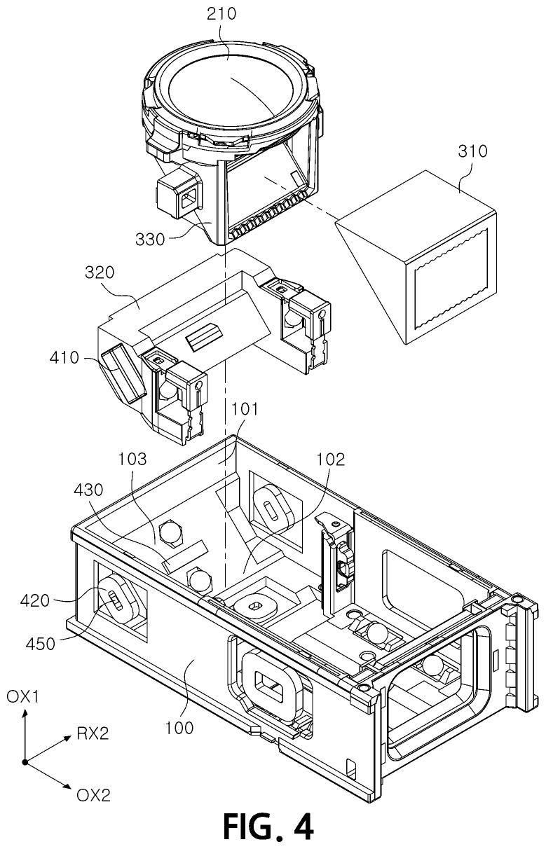

FIG. 3 is a cross-sectional diagram taken along line I-I′ in FIG. 1. FIG. 4 is an exploded perspective diagram illustrating a reflective module according to an embodiment.

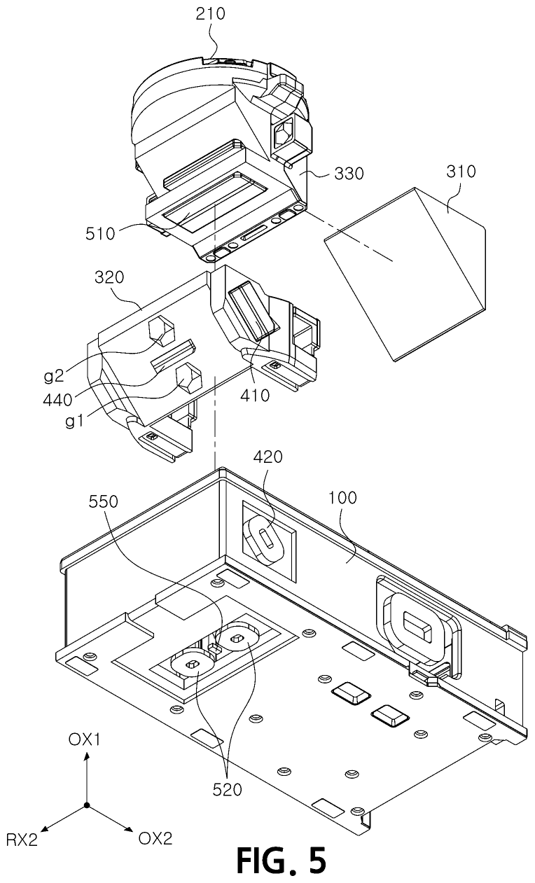

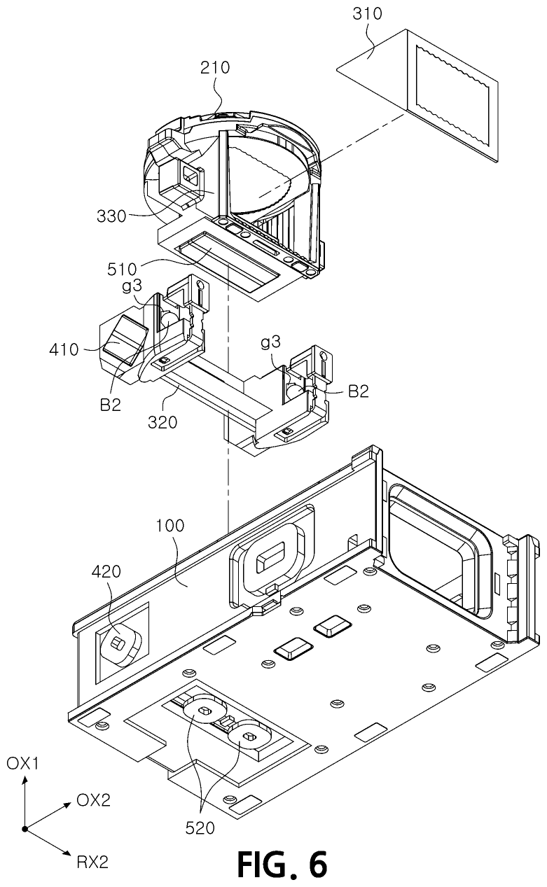

FIGS. 5 and 6 are diagrams illustrating the example in FIG. 4, viewed in different directions.

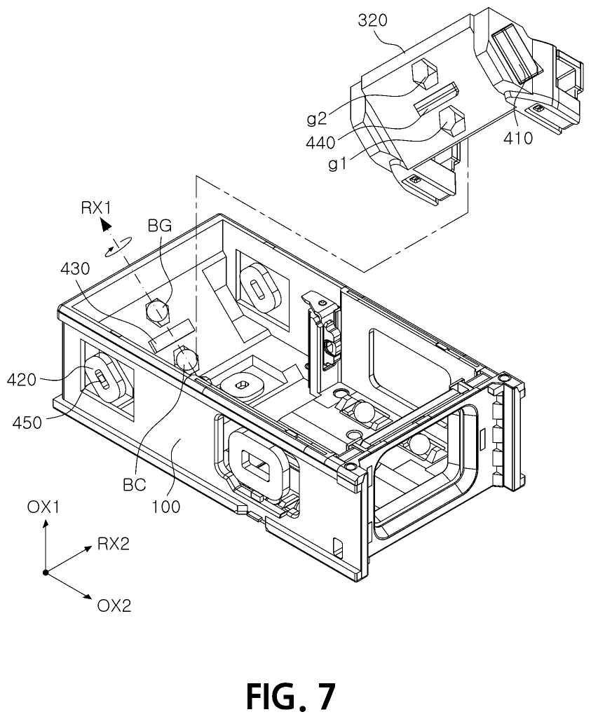

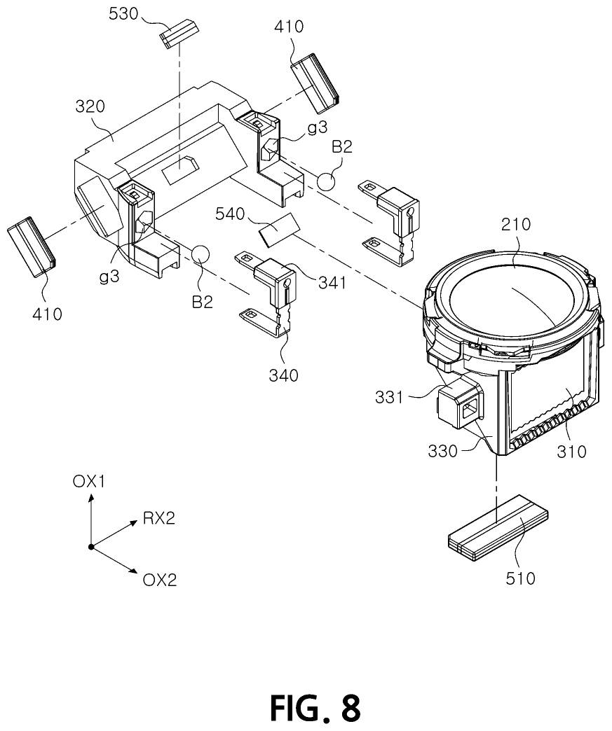

FIG. 7 is an exploded perspective diagram illustrating a housing and a guide member according to an embodiment of the present disclosure. FIG. 8 is a diagram illustrating a modified example of FIG. 7.

Referring to FIGS. 3 to 8, a reflective module 300 may include a reflective member 310, a holder 330, and a guide member 320.

The reflective member 310 may have a reflective surface 311 configured to reflect light having passed through the first lens module 210. For example, the reflective member 310 may be configured as a prism or a mirror.

When the reflective member 310 is a prism, the reflective member 310 may have a shape obtained by dividing a rectangular solid (or a cube) into two halves in a diagonal direction. The prism may include an incident surface to which light is incident, a reflective surface 311 configured to reflect light having passed through the incident surface, and an exit surface from which light reflected from the reflective surface 311 is emitted.

The reflective member 310 may be mounted on the holder 330. The first lens module 210 may be disposed on a front side of the reflective member 310. In an embodiment, the first lens module 210 may be mounted on the holder 330.

The holder 330 may be disposed on the guide member 320 and may rotate. The guide member 320 may be disposed on the housing 100 and may rotate.

The guide member 320 may rotate about the first rotation axis RX1. For example, the guide member 320 may rotate relative to the housing 100 about the first rotation axis RX1. In this case, the first lens module 210 and the holder 330 may also rotate together with the guide member 320

The first rotation axis RX1 may be configured to be inclined with respect to the first optical axis OX1 and may also be configured to be inclined with respect to the second optical axis OX2.

In an embodiment, the first rotation axis RX1 may be parallel to the reflective surface 311 of the reflective member 310. That is, the first rotation axis RX1 may be an axis extending parallel to the reflective surface 311 and may not intersect the reflective surface 311.

In embodiments, “parallel” may indicate a physically completely parallel state, and may also include manufacturing tolerances.

The holder 330 may rotate about a second rotation axis RX2 perpendicular to the first rotation axis RX1. For example, the holder 330 may rotate relative to the guide member 320 about the second rotation axis RX2. In this case, the first lens module 210 may rotate together with the holder 330.

The second rotation axis RX2 may be perpendicular to both the first optical axis OX1 and the second optical axis OX2.

A first driving unit 400 may be provided to rotate the guide member 320. The first driving unit 400 may include a first magnet 410 and a first coil 420. The guide member 320 may rotate relative to the housing 100 with respect to the first rotation axis RX1 by the first driving unit 400. Since the holder 330 and the first lens module 210 are disposed in the guide member 320, the holder 330 and the first lens module 210 may also rotate together with the guide member 320.

The first magnet 410 may be mounted on the guide member 320. For example, the first magnet 410 may be mounted on a side surface of the guide member 320. The side surface of the guide member 320 may indicate a surface opposing the housing 100 in the second rotation axis RX2 direction.

The first magnet 410 may be configured as one or more magnets. When the first magnet 410 includes only one magnet, the first magnet 410 may be disposed on one side surface of the guide member 320.

When the first magnet 410 includes two magnets, the two magnets may be spaced apart from each other in the second rotation axis RX2 direction. In an embodiment, one of the two magnets may be disposed on one side surface of the guide member 320, and the other may be disposed on the other side surface of the guide member 320.

The first magnet 410 may be magnetized such that one surface (e.g., the surface opposing the first coil 420) may have a first polarity and a second polarity. The first polarity and the second polarity may indicate opposite polarities, and when the first polarity is an N-pole, the second polarity may be an S-pole.

In an embodiment, one surface of the first magnet 410 opposing the first coil 420 may have a first polarity and a second polarity, and a neutral region may be formed between the first polarity and the second polarity.

The first polarity and the second polarity may be spaced apart from each other in a direction perpendicular to the first rotation axis RX1. The neutral region may be formed to have a length in the first rotation axis RX1 direction.

The length direction of the neutral region may be measured by applying liquid iron to one surface of the first magnet 410. For example, liquid iron may not be attached to the neutral region, and may be attached only to a portion having the first polarity and the second polarity. Accordingly, the length direction of the neutral region may be defined through the region in which liquid iron is not attached.

The first coil 420 may be disposed in a position opposing the first magnet 410. In an embodiment, the first coil 420 may be disposed to oppose the first magnet 410 in the second rotation axis RX2 direction.

The first coil 420 may be disposed on the substrate 900, and the substrate 900 may be mounted on the housing 100 such that the first magnet 410 and the first coil 420 may oppose each other in the second rotation axis RX2 direction.

The housing 100 may include a through-hole penetrating the housing 100 in the second rotation axis RX2 direction, and the first coil 420 may be disposed in the through-hole and may directly oppose the first magnet 410.

During optical image stabilization, the first magnet 410 may be a moving member mounted on the guide member 320 and rotating together with the guide member 320, and the first coil 420 may be a fixed member fixed to the substrate 900.

When power is applied to the first driving unit 400, the first driving unit 400 may generate a driving force desired for the rotation of the guide member 320 with respect to the first rotation axis RX1.

The first ball member B1 may be disposed between the guide member 320 and the housing 100. The first ball member B1 may be disposed between the guide member 320 and the housing 100 and may form a rotation axis of the guide member 320.

The first ball member B1 may include a plurality of balls spaced apart from each other in the first rotation axis RX1 direction. A conceptual line connecting the plurality of balls of the first ball member B1 in the first rotation axis RX1 direction may be spaced apart from the first magnet 410 in the second rotation axis RX2 direction.

In an embodiment, the first magnet 410 and the first coil 420 may be spaced apart from the first ball member B1 in the second rotation axis RX2 direction. When a driving force is generated in a direction perpendicular to the first rotation axis RX1 by the first magnet 410 and the first coil 420, the guide member 320 may rotate with respect to the rotation axis formed by the first ball member B1.

The conceptual line connecting the plurality of balls of the first ball member B1 in the first rotation axis RX1 direction may be parallel to the reflective surface 311 of the reflective member 310.

Attractive force may be applied between the guide member 320 and the housing 100.

In an embodiment, the first magnetic component 430 may be disposed in one of the housing 100 and the guide member 320, and the second magnetic component 440 may be disposed in the other.

The first magnetic component 430 and the second magnetic component 440 may oppose each other in a direction perpendicular to the first rotation axis RX1.

Referring to FIG. 7, the first magnetic component 430 may be disposed in housing 100, and the second magnetic component 440 may be disposed in the guide member 320. The first magnetic component 430 may be a yoke, and the second magnetic component 440 may be a magnet. Alternatively, both the first magnetic component 430 and the second magnetic component 440 may be provided as magnets.

The first magnetic component 430 and the second magnetic component 440 may generate an attractive force therebetween. Attractive force may act between the first magnetic component 430 and the second magnetic component 440 in a direction perpendicular to the first rotation axis RX1.

The first ball member B1 may maintain a state of being in contact with each of the guide member 320 and the housing 100 by the attractive force between the first magnetic component 430 and the second magnetic component 440.

In the embodiment illustrated in FIG. 7, the first magnetic component 430 and the second magnetic component 440 may be disposed between a plurality of balls of the first ball member B1.

A first guide groove g1 and a second guide groove g2 may be disposed on surfaces (e.g., surfaces opposing each other in the direction of the first rotation axis RX1) of the guide member 320 and the housing 100 opposing each other. The first guide groove g1 and the second guide groove g2 may be spaced apart from each other in the first rotation axis RX1 direction.

In an embodiment, the housing 100 may include a side surface 101 and a bottom surface 102 perpendicular to each other, and may further include an inclined surface 103 disposed between the side surface 101 and the bottom surface 102.

The inclined surface 103 of the housing 100 may be an inclined surface, inclined with respect to the first optical axis OX1 of the first lens module 210. Also, the inclined surface 103 of the housing 100 may be an inclined surface, inclined with respect to the second optical axis OX2 of the second lens module 220

The guide member 320 may include an inclined surface, and the inclined surface of the guide member 320 and the inclined surface 103 of the housing 100 may oppose each other in the first rotation axis RX1 direction.

The first guide groove g1 and the second guide groove g2 may be formed on the inclined surface of the guide member 320 and the inclined surface 103 of the housing 100, respectively.

Levels of the plurality of balls of the first ball member B1 may be different with respect to the bottom surface 102 of the housing 100. For example, when the first ball member B1 includes two balls, the two balls may be positioned at different levels. Here, the level may indicate the level in the first optical axis OX1 direction.

In an embodiment, a distance from the bottom surface 102 of the housing 100 to the rotation axis ball BC in the first optical axis OX1 direction may be different from a distance from the bottom surface 102 of the housing 100 to the plurality of guide balls BG in the first optical axis OX1 direction.

The plurality of balls of the first ball member B1 may be disposed in the first guide groove g1 and the second guide groove g2, respectively.

The plurality of balls of the first ball member B1 may be disposed in the first guide groove g1 and the second guide groove g2, and may form the first rotation axis RX1 of the guide member 320.

The first magnetic component 430 may be disposed between the first guide groove g1 and the second guide groove g2 of the housing 100, and the second magnetic component 440 may be disposed between the first guide groove g1 and the second guide groove g2 of the guide member 320.

The reflective module 300 may sense a position of the guide member 320. To this end, a first position sensor 450 may be provided. The first position sensor 450 may be a Hall sensor.

The first position sensor 450 may be disposed to oppose the first magnet 410. In an embodiment, the first position sensor 450 may be disposed to oppose the neutral region of the first magnet 410 in a first original position. Here, the first original position may indicate a state in which the guide member 320 does not rotate with respect to the first rotation axis RX1, for example, a state in which the first magnet 410 and the first coil 420 are parallel to each other.

The first position sensor 450 may be disposed on the substrate 900.

When guide member 320 rotates about the first rotation axis RX1, a position of guide member 320 may be sensed through the first position sensor 450.

A second driving unit 500 may be provided to rotate the holder 330. The second driving unit 500 may include a second magnet 510 and a second coil 520. The holder 330 may rotate about the second rotation axis RX2 by the second driving unit 500. Since the first lens module 210 is disposed in the holder 330, the first lens module 210 may also rotate together with the holder 330.

The second magnet 510 may be mounted on the holder 330. For example, the second magnet 510 may be mounted on a lower surface of the holder 330.

The second magnet 510 may be magnetized such that one surface (e.g., the surface opposing the second coil 520) thereof may have both a first polarity and a second polarity. In an embodiment, one surface of the second magnet 510 opposing the second coil 520 may be sequentially magnetized with the first polarity and the second polarity in the second optical axis OX2 direction, and a neutral region may be formed between the first polarity and the second polarity.

The second magnet 510 may have a shape having a length in the second rotation axis RX2 direction.

The second coil 520 may be disposed in a position opposing the second magnet 510. In an embodiment, the second coil 520 may be disposed to oppose the second magnet 510 in the first optical axis OX1 direction.

The second coil 520 may include two coils. The two coils may be spaced apart from each other in the second rotation axis RX2 direction.

The second coil 520 may be disposed in the substrate 900, and the substrate 900 may be mounted on the housing 100 such that the second magnet 510 and the second coil 520 may oppose each other in the first optical axis OX1 direction.

The housing 100 may include a through-hole penetrating the housing 100 in the first optical axis OX1 direction, and the second coil 520 may be disposed in the through-hole and may directly oppose the second magnet 510.

During optical image stabilization, the second magnet 510 may be a moving member mounted on the holder 330 and rotating together with the holder 330, and the second coil 520 may be a fixed member fixed to the substrate 900.

When power is applied to the second driving unit 500, the second driving unit 500 may generate a driving force desired for rotation of the holder 330 with respect to the second rotation axis RX2. The second driving unit 500 may generate a driving force in the second optical axis OX2 direction.

A second ball member B2 may be disposed between the holder 330 and the guide member 320. The second ball member B2 may be disposed between the holder 330 and the guide member 320 and may form a rotation axis of the holder 330.

The second ball member B2 may include a plurality of balls spaced apart from each other in the second rotation axis RX2 direction. A reflective member 310 may be disposed between the plurality of balls of the second ball member B2.

When viewed from the second rotation axis RX2 direction, a portion of the reflective surface 311 of the reflective member 310 may overlap the second ball member B2.

A conceptual line connecting the plurality of balls of the second ball member B2 in the second rotation axis RX2 direction may pass through the reflective surface of the reflective member 310.

Attractive force may act between the holder 330 and the guide member 320. In an embodiment, a third magnetic component 530 may be disposed in one of the holder 330 and the guide member 320, and a fourth magnetic component 540 may be disposed in the other. One of the third magnetic component 530 and the fourth magnetic component 540 may be a magnet, and the other may be a yoke. In another embodiment, both the third magnetic component 530 and the fourth magnetic component 540 may be provided as magnets.

In an embodiment, a third magnetic component 530 may be disposed in the guide member 320, and a fourth magnetic component 540 may be disposed in the holder 330. The third magnetic component 530 may be a magnet, and the fourth magnetic component 540 may be a yoke.

One surface of the third magnetic component 530 (e.g., a surface opposing the fourth magnetic component 540) may be magnetized with a first polarity and a second polarity in a direction parallel to the reflective surface of the reflective member 310.

The third magnetic component 530 and the fourth magnetic component 540 may oppose each other in the first rotation axis RX1 direction.

The third magnetic component 530 and the fourth magnetic component 540 may generate an attractive force therebetween. Attractive force may act between the third magnetic component 530 and the fourth magnetic component 540 in the first rotation axis RX1 direction.

The second ball member B2 may maintain a state of being in contact with each of the holder 330 and the guide member 320 by the attractive force between the third magnetic component 530 and the fourth magnetic component 540.

A third guide groove g3 may be disposed on each of the surfaces (e.g., surfaces opposing the second optical axis OX2 direction) of the holder 330 and the guide member 320 opposing each other.

In an embodiment, the holder 330 may include a guide projection 331. The guide projection 331 may protrude from both side surfaces of the holder 330 in the second rotation axis RX2 direction. The third guide groove g3 of the holder 330 may be formed on the guide projection 331

The second ball member B2 may be disposed between the third guide groove g3 of the holder 330 and the third guide groove g3 of the guide member 320 and may form a rotation axis of the holder 330.

The reflective module 300 may sense a position of the holder 330. To this end, a second position sensor 550 may be provided. The second position sensor 550 may be configured as a Hall sensor.

The second position sensor 550 may be disposed to oppose the second magnet 510. In an embodiment, the second position sensor 550 may be disposed to oppose a neutral region of the second magnet 510 in a second original position. Here, the second original position may indicate a state in which the holder 330 does not rotate with respect to the second rotation axis RX2, for example, a state in which the second magnet 510 and the second coil 520 are parallel to each other.

When the second coil 520 includes two coils, the second position sensor 550 may be disposed between the two coils.

The second position sensor 550 may be disposed on the substrate 900.

When the holder 330 rotates with respect to the second rotation axis RX2, a position of the guide member 320 may be sensed through the second position sensor 550.

the reflective module 300 may further include the first stopper 340. The first stopper 340 may be coupled to the guide member 320 so as to cover at least a portion of the holder 330. For example, the first stopper 340 may surround or cover at least a portion of the guide projection 331 of the holder 330. The first stopper 340 and the holder 330 may be spaced apart from each other.

Since the first stopper 340 is spaced apart from the holder 330, the holder 330 may be prevented from being separated from the guide member 320 due to external impact without interfering with the rotation of the holder 330.

A buffer member 341 having elasticity may be coupled to the first stopper 340. The buffer member 341 may be disposed on either one or both of one surface and the other surface of the first stopper 340, opposing the holder 330.

Referring to FIG. 6, a spacer may be disposed on a lower surface (that is, the surface opposing the reflective member 310) of the first lens module 210. The spacer may have an entrance hole through which light passes, and the entrance hole may be non-circular. For example, the entrance hole may have a running-track shape. That is, an internal side surface of the spacer forming the entrance hole may include two planes extending parallel to each other, and two curved surfaces connecting the two planes to each other.

The internal side surface of the spacer may have a waveform in which concave shapes and convex shapes are repeated, and may thus prevent flares.

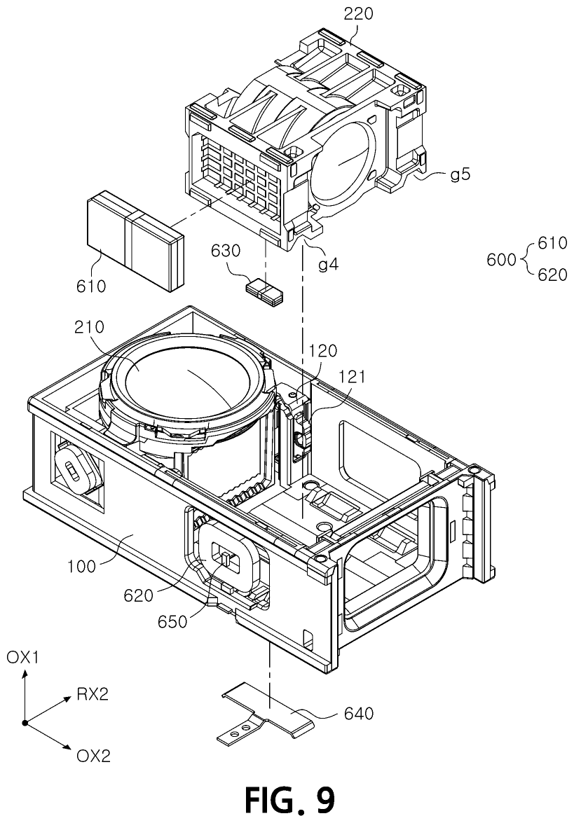

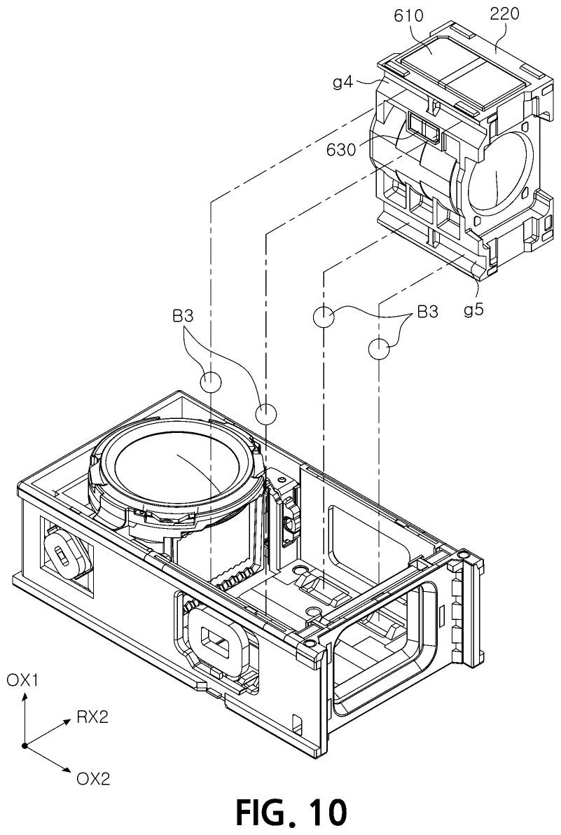

FIGS. 9 and 10 are perspective diagrams illustrating a state in which a second lens module is separated from a camera module according to an embodiment.

Referring to FIGS. 9 and 10, a second lens module 220 may be disposed between a reflective module 300 and an image sensor module 800.

The second lens module 220 may move in the second optical axis OX2 direction for focusing.

In an embodiment, the second lens module 220 may include a plurality of lenses and a second lens barrel. The plurality of lenses may be disposed in the second lens barrel.

The camera module 1 may include a third driving unit 600 to move the second lens module 220 in the second optical axis OX2 direction.

The third driving unit 600 may include a third magnet 610 and a third coil 620. The third magnet 610 and the third coil 620 may be disposed to oppose each other in a direction perpendicular to the second optical axis OX2 direction.

The third magnet 610 may be mounted on the second lens module 220. For example, the third magnet 610 may be disposed on one side surface (e.g., one side surface of the second lens barrel) of the second lens module 220.

In an embodiment, the second lens module 220 may include one side surface and the other side surface spaced apart from each other in the second rotation axis RX2 direction. The third magnet 610 may be disposed on one side surface of the second lens module 220.

The third magnet 610 may be magnetized such that one surface (e.g., the surface opposing the third coil 620) may have both a first polarity and a second polarity. For example, one surface of the third magnet 610 opposing the third coil 620 may be sequentially provided with the first polarity and the second polarity in the second rotation axis RX2 direction. A neutral region may be formed between the first polarity and the second polarity.

The third coil 620 may be disposed to oppose the third magnet 610. For example, the third coil 620 may be disposed to oppose the third magnet 610 in a direction perpendicular to the second optical axis OX2 direction (e.g., the second rotation axis RX2 direction).

The third coil 620 may be disposed in the substrate 900, and the substrate 900 may be mounted on the housing 100 such that the third magnet 610 and the third coil 620 may oppose each other in the second rotation axis RX2 direction.

The housing 100 may include a through-hole penetrating the housing 100, and the third coil 620 disposed in the substrate 900 may directly oppose the third magnet 610 through a through-hole.

When focusing, the third magnet 610 may be a moving member mounted on the second lens module 220 and moving in the second optical axis OX2 direction together with the second lens module 220, and the third coil 620 may be a fixed member fixed to the substrate 900.

When power is applied to the third coil 620, the second lens module 220 may move in the second optical axis OX2 direction by an electromagnetic force between the third magnet 610 and the third coil 620.

The third ball member B3 may be disposed between the second lens module 220 and the housing 100, and the second lens module 220 may move in the second optical axis OX2 direction guided by the third ball member B3. The third ball member B3 may include at least three balls.

A fifth magnetic component 630 may be disposed in one of the second lens module 220 and the housing 100, and the sixth magnetic component 640 may be disposed in the other. One of the fifth magnetic component 630 and the sixth magnetic component 640 may be a magnet and the other may be a yoke. In another embodiment, both the fifth magnetic component 630 and the sixth magnetic component 640 may be provided as magnets.

In an embodiment, the fifth magnetic component 630 may be disposed on a lower surface of the second lens module 220, and the sixth magnetic component 640 may be disposed on the internal bottom surface of the housing 100. The fifth magnetic component 630 may be a magnet, and the sixth magnetic component 640 may be a yoke.

The fifth magnetic component 630 may be disposed closer to one side surface of the second lens module 220. That is, the fifth magnetic component 630 may be disposed closer to one side surface of the second lens module 220 than to the other side surface of the second lens module 220. Also, the fifth magnetic component 630 may be disposed between one side surface of the second lens module 220 and the second optical axis OX2.

The fifth magnetic component 630 and the sixth magnetic component 640 may be disposed to oppose each other in the first optical axis OX1 direction.

The fifth magnetic component 630 and the sixth magnetic component 640 may generate an attractive force therebetween. For example, attractive force may act between the fifth magnetic component 630 and the sixth magnetic component 640 in the first optical axis OX1 direction.

The third ball member B3 may be in contact with each of the second lens module 220 and the housing 100 by the attractive force between the fifth magnetic component 630 and the sixth magnetic component 640.

A portion of the plurality of balls of the third ball member B3 may be disposed closer to one side surface of the second lens module 220 than the other side surface, and the other portion of the plurality of balls of the third ball member B3 may be disposed closer to the other side surface of the second lens module 220 than the one side surface.

The plurality of balls disposed between the one side surface of the second lens module 220 and the second optical axis OX2 may be spaced apart from each other in the second optical axis OX2 direction.

The fourth guide groove g4 and the fifth guide groove g5 may be disposed on the surfaces of the second lens module 220 and the housing 100, opposing each other, respectively. For example, the fourth guide groove g4 may be disposed on one side of the surfaces of the second lens module 220 and the housing 100 opposing each other, and the fifth guide groove g5 may be disposed on the other side of the surfaces of the second lens module 220 and the housing 100 opposing each other.

The fourth guide groove g4 and the fifth guide groove g5 may be spaced apart from each other in the second rotation axis RX2 direction.

The fourth guide groove g4 and the fifth guide groove g5 may extend in a direction parallel to the second optical axis OX2.

A portion of the plurality of balls of the third ball member B3 may be disposed in the fourth guide groove g4, and the other of the plurality of balls of the third ball member B3 may be disposed in the fifth guide groove g5.

The number of contact points between a portion of the plurality of balls of the third ball member B3 and the fourth guide groove g4 may be greater than the number of contact points between the other of the plurality of balls of the third ball member B3 and the fifth guide groove g5.

The fourth guide groove g4 may be disposed closer to one side surface of the second lens module 220 than the fifth guide groove g5.

The fifth magnetic component 630 may be disposed closer to the fourth guide groove g4 than to the fifth guide groove g5.

In an embodiment, the camera module 1 may sense a position of the second lens module 220. To this end, a third position sensor 650 may be provided. The third position sensor 650 may be disposed in a position opposing the third magnet 610 of the third driving unit 600 (e.g., a position opposing the second rotation axis RX2 direction).

Accordingly, when the second lens module 220 moves in the second optical axis OX2 direction, the position of the second lens module 220 may be sensed through the third position sensor 650.

The third position sensor 650 may be configured as a Hall sensor.

The camera module 1 may further include a second stopper 120. The second stopper 120 may be coupled to the housing 100 and may oppose the second lens module 220 in the second optical axis OX2 direction.

The second stopper 120 may be coupled to a buffer member 121 having elasticity. For example, the second stopper 120 opposing the second lens module 220 in the second optical axis OX2 direction may include the buffer member 121.

According to the aforementioned embodiments, a reflective module and a camera module including the same may perform image stabilization during photographing and may have a reduced size.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module, comprising:
a housing;
a guide member disposed in the housing and configured to rotate about a first rotation axis;
a reflective member configured to rotate together with the guide member about the first rotation axis and having a reflective surface; and
a first ball member disposed between the housing and the guide member,
wherein the first rotation axis is formed to be inclined with respect to each of a side surface and a bottom surface of the housing.

2. The reflective module of claim 1, wherein the first rotation axis is parallel to the reflective surface.

3. The reflective module of claim 1,
wherein the housing comprises an inclined surface disposed between the side surface and the bottom surface, and
wherein the guide member has a surface opposing the inclined surface in a direction perpendicular to the first rotation axis.

4. The reflective module of claim 1, wherein the first ball member comprises a plurality of balls spaced apart from each other in a direction of the first rotation axis.

5. The reflective module of claim 4,
wherein the housing comprises an inclined surface disposed between the side surface and the bottom surface, and
wherein guide grooves spaced apart from each other in the direction of the first rotation axis are disposed in the inclined surface, and the first ball member is disposed in the guide grooves.

6. The reflective module of claim 1, further comprising:
a first driving unit comprising a first magnet disposed on the guide member and a first coil opposing the first magnet,
wherein the first magnet and the first coil are configured to generate a driving force in a direction perpendicular to the first rotation axis.

7. The reflective module of claim 6,
wherein one surface of the first magnet, opposing the first coil, has a first polarity and a second polarity spaced apart from each other in a direction perpendicular to the first rotation axis, and
wherein the first polarity and the second polarity are opposite polarities.

8. The reflective module of claim 1, wherein a first magnetic component is disposed in one of the housing and the guide member, a second magnetic component is disposed in another of the housing and the guide member, and the first magnetic component and the second magnetic component oppose each other.

9. The reflective module of claim 8,
wherein the first ball member is disposed between the housing and the guide member,
wherein the first ball member comprises a plurality of balls spaced apart from each other in the direction of the first rotation axis, and
wherein the first magnetic component and the second magnetic component are disposed between the plurality of balls.

10. The reflective module of claim 1, further comprising:
a holder disposed to rotate about the guide member with respect to a second rotation axis perpendicular to the first rotation axis,
wherein the reflective member is mounted on the holder.

11. The reflective module of claim 10, further comprising:
a second driving unit comprising a second magnet disposed on the holder and a second coil opposing the second magnet; and
a second ball member, disposed between the guide member and the holder, comprising a plurality of balls spaced apart from each other in a direction of the second rotation axis.

12. A camera module, comprising:
the reflective module of claim 1; and
a first lens module having a first optical axis and spaced apart from the reflective member in a direction of the first optical axis.

13. A camera module, comprising:
a housing;
a guide member disposed to rotate about a first rotation axis with respect to the housing;
a reflective member having a reflective surface and configured to rotate together with the guide member about the first rotation axis;
a first lens module having a first optical axis and spaced apart from the reflective member in a direction of the first optical axis; and
a first ball member disposed between the guide member and the housing,
wherein the housing has an inclined surface, inclined with respect to the first optical axis, and
wherein the first ball member is disposed on the inclined surface.

14. The camera module of claim 13, further comprising:
a second lens module to which light reflected from the reflective surface is incident, and having a second optical axis,
wherein the first optical axis and the second optical axis are perpendicular to each other.

15. The camera module of claim 14,
wherein the first ball member comprises a plurality of balls spaced apart from each other in the direction of the first rotation axis, and
wherein a conceptual line connecting the plurality of balls is inclined with respect to each of the first optical axis and the second optical axis.

16. The camera module of claim 13, wherein the first rotation axis is parallel to the reflective surface.
